(19) United States
(12) Patent Application Publication
(10) Pub. No.: US 2021/0017854 A1
(43) Pub. Date: Jan. 21, 2021

(54) SYSTEM AND METHOD FOR RECOVERING A SLOT AND FORMING A WHIPSTOCK CASING EXIT IN A TUBULAR

(71) Applicant: Lei FANG, Houston, TX (US)

(72) Inventor: Lei FANG, Houston, TX (US)

(73) Assignee: Baker Hughes Oilfield Operations LLC, Houston, TX (US)

(21) Appl. No.: 16/511,058

(22) Filed: Jul. 15, 2019

(51) Int. Cl. E21B 47/09; E21B 29/06; E21B 47/00; E21B 49/00; G01B 17/02

(52) U.S. Cl. CPC E21B 47/091; E21B 29/06; E21B 47/12; E21B 49/00; G01B 17/02; E21B 47/0005

(57) ABSTRACT

A method of forming a casing window in a casing tubular includes introducing a bottom hole assembly (BHA) into a casing tubular, running the bottom hole assembly to a selected position in the casing tubular, directing an ultrasonic wave from the BHA toward the casing tubular, receiving a reflection of the ultrasonic wave at the BHA, and evaluating the reflection of the ultrasonic wave to determine one or more parameters associated with the casing tubular and supporting structure.

### BACKGROUND

In the drilling and completion industry, it may be desirable to recover a casing slot and/or to form a window in a casing tubular that lines a wellbore formed in a formation. The window may form an exit for a drillstring that is being operated to form a non-vertical wellbore portion. To form the window, a clean out bottom hole assembly (BHA) is run into the wellbore to clean/clear internal surfaces of a section of the casing tubular. At this point, a whipstock, having an angled surface, is run into the wellbore and anchored at the section of the casing tubular. A casing exit BHA including a window mill may then be guided into the wellbore. The window mill passes along the angled surface, engages the casing tubular, and forms an opening.

When forming the window, it is helpful to avoid hitting a collar that joins two segments of the casing tubular. Hitting the casing collar could lead to a collar spin that may block the window. It is also helpful to form the window at a section of the casing tubular that is supported by cement. Lack of support can compromise window integrity. Further, any issues during window formation could trigger a need for a window polishing operation. Given the number of factors that come into play when forming a casing window, the art would be open to new systems that reduce the need for multiple trips and lower the likelihood that issues may arise.

### SUMMARY

Disclosed is a method of forming a casing window in a casing tubular including introducing a bottom hole assembly (BHA) into a casing tubular, running the bottom hole assembly to a selected position in the casing tubular, directing an ultrasonic wave from the BHA toward the casing tubular, receiving a reflection of the ultrasonic wave at the BHA, and evaluating the reflection of the ultrasonic wave to determine one or more parameters associated with the casing tubular and supporting structure.

Also disclosed is a bottom hole assembly (BHA) including a tubular member, at least one tool supported by the tubular member, and an ultrasonic sensor system mounted to the tubular member. The ultrasonic sensor system includes at least one transceiver and at least one receiver, the at least one transceiver is mounted to project a ultrasonic wave radially outwardly of the tubular member.

Further disclosed is a resource exploration and recovery system including a surface system, and a subsurface system including a tubular string supporting a bottom hole assembly (BHA) including a tubular member, at least one tool supported by the tubular member, and an ultrasonic sensor system mounted to the tubular member. The ultrasonic sensor system includes at least one transceiver and at least one receiver. The at least one transceiver is mounted to project a ultrasonic wave radially outwardly of the tubular member.

### BRIEF DESCRIPTION OF THE DRAWINGS

The following descriptions should not be considered limiting in any way. With reference to the accompanying drawings, like elements are numbered alike:

FIG. 1 depicts a resource exploration and recovery system including a bottom hole assembly (BHA) having an ultrasonic sensor system, in accordance with an aspect of an exemplary embodiment;

FIG. 2 depicts a casing cleanout BHA including the ultrasonic sensor system, in accordance with an exemplary aspect;

FIG. 3 depicts a casing exit BHA including the ultrasonic sensor system, in accordance with an exemplary aspect;

FIG. 4 depicts a cut and pull BHA including the ultrasonic sensor system, in accordance with an exemplary aspect; and

FIG. 5 depicts the casing exit BHA forming a window in a casing tubular, in accordance with an aspect of an exemplary embodiment.

### DETAILED DESCRIPTION

A detailed description of one or more embodiments of the disclosed apparatus and method are presented herein by way of exemplification and not limitation with reference to the Figures.

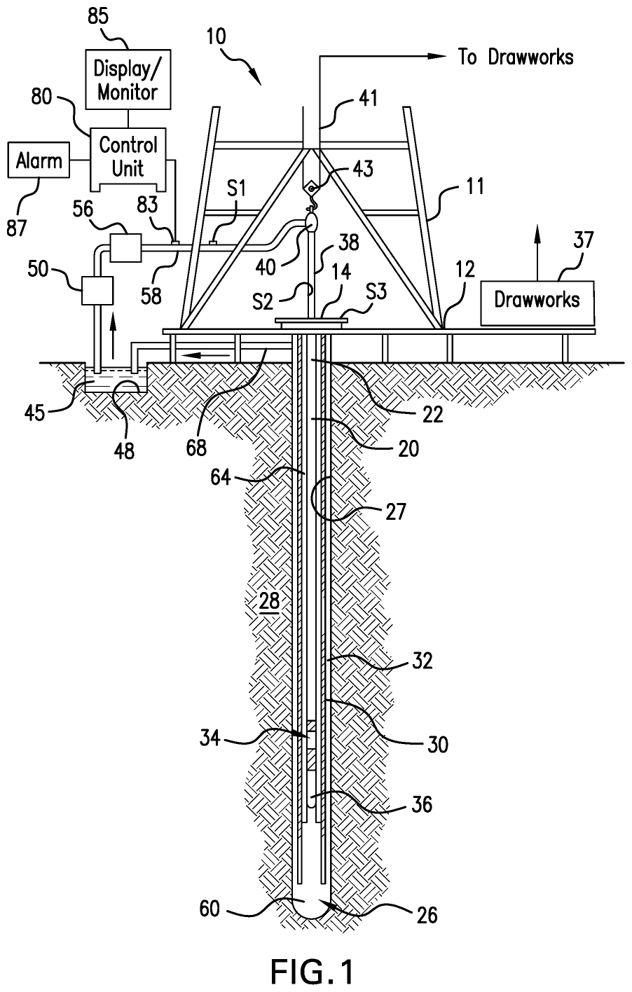

FIG. 1 shows a schematic diagram of a resource exploration and recovery system for performing downhole operations. As shown, the resource exploration and recovery system takes the form of a drilling system 10. Drilling system 10 includes a conventional derrick 11 erected on a floor 12 that supports a rotary table 14 that is rotated by a prime mover, such as an electric motor (not shown), at a desired rotational speed. A drill string 20 extends through rotary table 14 and includes a drilling tubular 22, such as a drill pipe into a borehole 26 having an annular wall 27 extending into a geological formation 28. Borehole 26 is supported by a casing tubular 30. A cement liner 32 is formed between annular wall 27 and an outer surface (not separately labeled) of casing tubular 30. A bottom hole assembly (BHA) 34 is attached to the end of drillstring 20. BHA 34 may take the form of a cleanout BHA 36 that is run into casing tubular 30 following a cementing operation and prior to a window cutting operation as will be detailed herein.

Drill string 20 is coupled to surface equipment such as systems for lifting, rotating, and/or pushing, including, but not limited to, a drawworks 37 via a kelly joint 38, swivel 40 and line 41 through a pulley 43. In some embodiments, the surface equipment may include a top drive (not shown). During the drilling operations, drawworks 37 is operated to control weight on bit (WOB) of BHA 34, which affects a rate of penetration into geological formation 28. The operation of the drawworks 37 is well known in the art and is thus not described in detail herein.

During drilling operations a suitable drilling fluid 45 (also referred to as the “mud”) from a source or mud pit 48 is circulated under pressure through the drill string 20 by a mud pump 50. Drilling fluid 45 passes into drill string 20 via a desurger 56, fluid line 58 and kelly joint 38. Drilling fluid 45 is discharged at a bottom 60 of borehole 26 through an opening in disintegrating tool 30. Drilling fluid 45 circulates uphole through an annular space 64 between the drill string 20 and annular wall 27 of borehole 26 and returns to mud pit 48 via a return line 68. A sensor S1 in fluid line 58 provides information about the fluid flow rate. A surface torque sensor S2 and a sensor S3 associated with drill string 20 respectively provide information about torque and rotational speed of drilling tubular 22. Additionally, one or more sensors (not shown) associated with line 41 are used to provide hook load data of drill string 20 as well as other desired parameters relating to the drilling of borehole 26. Drilling system 10 may further include one or more downhole sensors (not shown) located on the drill string 20 and/or BHA 34.

As will also be detailed herein, a surface control unit 80 receives signals from BHA 34 via a transducer 83, such as a pressure transducer, placed in fluid line 58 as well as from sensors S1, S2, S3, hook load sensors, RPM sensors, torque sensors, and any other sensors. Surface control unit 80 may also be configured to communicate with cleanout BHA 34 through a wireless receiver, and/or a signal conductor. Surface control unit 80 processes such signals according to programmed instructions. Surface control unit 80 may display desired drilling parameters and other information on a display/monitor 85 for use by an operator at the rig site to control drilling operations.

Surface control unit 80 contains a computer, memory for storing data, computer programs, models and algorithms accessible to a processor in the computer, a recorder, such as tape unit, memory unit, etc. for recording data and other peripherals. Surface control unit 80 may also include simulation models for use by the computer to processes data according to programmed instructions. Surface control unit 80 may respond to user commands entered through a suitable device, such as a keyboard. Surface control unit 80 is adapted to activate alarms 87 when certain unsafe or undesirable operating conditions occur. Although FIG. 1 is shown and described with respect to a casing cleanout operation, those of skill in the art will appreciate that similar configurations, albeit with different components, can be used for performing different downhole operations.

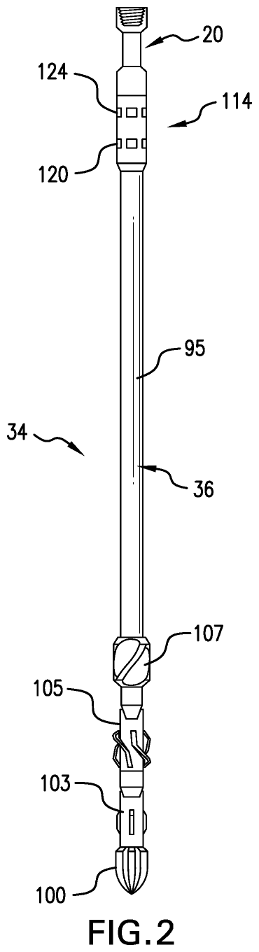

Referring to FIG. 2, cleanout BHA 36 includes a tubular 95 having a terminal end (not separately labeled) that supports a junk mill 100. Junk mill 100 is operated to remove cement or other debris that may be adhered to an inner surface (also not separately labeled) of casing tubular 30. Cleanout BHA 36 may also include a scraper 103, a string mill 105 and a stabilizer 107. Cleanout BHA 36 may also include additional components (not shown) associated with cleaning the inner surface of casing tubular 30 in preparation for a casing exit operation as will be detailed herein.

In accordance with an exemplary embodiment, cleanout BHA 36 includes an ultrasonic sensor system 114 that is operable to evaluate parameters at a selected position within casing tubular 30, cement liner 32, and/or geological formation 28. Ultrasonic sensor system 114 includes a plurality of transceivers 120 and a plurality of receivers 124. Transceivers 120 are arranged circumferentially about tubular 95 and are operable to emit an ultrasonic wave radially outwardly toward casing tubular 30. The ultrasonic wave may penetrate casing tubular 30, cement liner 32 and into geological formation 28. Receivers 124 are arranged circumferentially about tubular 95 and are operable to receive a reflection of the ultrasonic wave.

The reflected ultrasonic wave is captured by receivers 124 and may be transferred to surface control unit 80 for evaluation. The captured ultrasonic wave may be passed to surface control unit 80 through a wireless connection such as a series of pressure pulses (mud pulses), acoustic signals, electromagnetic signals or other communication protocols that may pass along the wellbore or through geological formation 28. The captured ultrasonic wave may also be passed to surface control unit 80 through a wired connection such as through a signal conductor. Operators at surface control system 80 may evaluate the reflected ultrasonic wave to identify whether a casing collar is present at the selected position. The reflected ultrasonic wave may also be evaluated to determine a thickness of casing tubular 30, a thickness or quality of concrete liner 32 and/or properties of geological formation 28 at the selected position. With this information, a determination may be made whether it is appropriate to form a casing exit at the selected position.

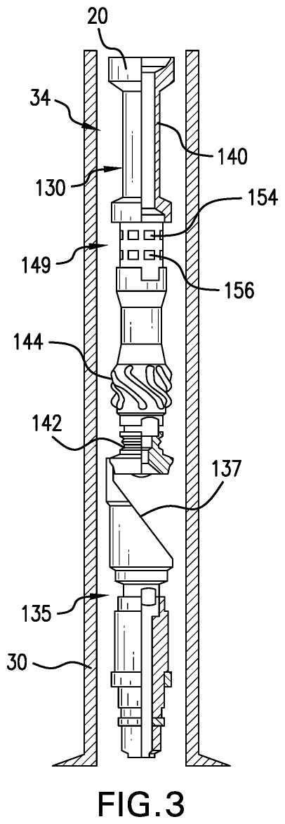

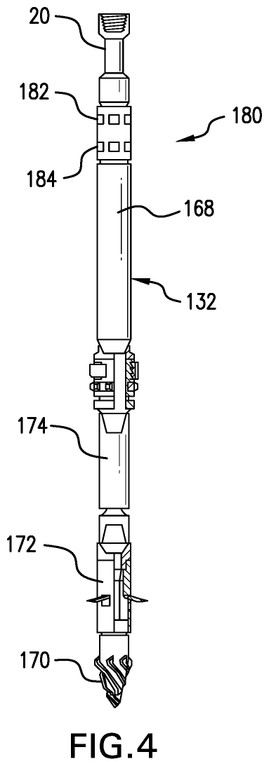

In accordance with an exemplary aspect, other BHA's may also include ultrasonic sensing capabilities. FIG. 3 depicts a casing exit BHA 130: FIG. 4 depicts a cut and pull BHA 132 each of which may include ultrasonic sensing capabilities. In an embodiment, after evaluating the reflected ultrasonic wave, a whipstock 135 may be installed in casing tubular 30 at the selected position by, for example, cleanout BHA 34. Whipstock 135 includes an angled or ramped surface 137 and may be anchored to casing tubular 30 at or near the selected location. The angled surface 137 guides casing exit BHA 130 to form a window in casing tubular 30.

In an embodiment, casing exit BHA 130 includes a tubular 140 that may be connected to drill string 20. Casing exit BHA 130 includes a window mill 142 and an upper mill 144. Casing exit BHA 130 may also include other window cutting components (not shown). In addition, casing exit BHA 130 includes an ultrasonic sensor system 149. In a manner similar to that discussed above, ultrasonic sensor system 149 includes a plurality of transceivers 154 and a plurality of receivers 156. Transceivers 154 are arranged circumferentially about tubular 140 and are operable to emit an ultrasonic wave radially outwardly toward casing tubular 30.

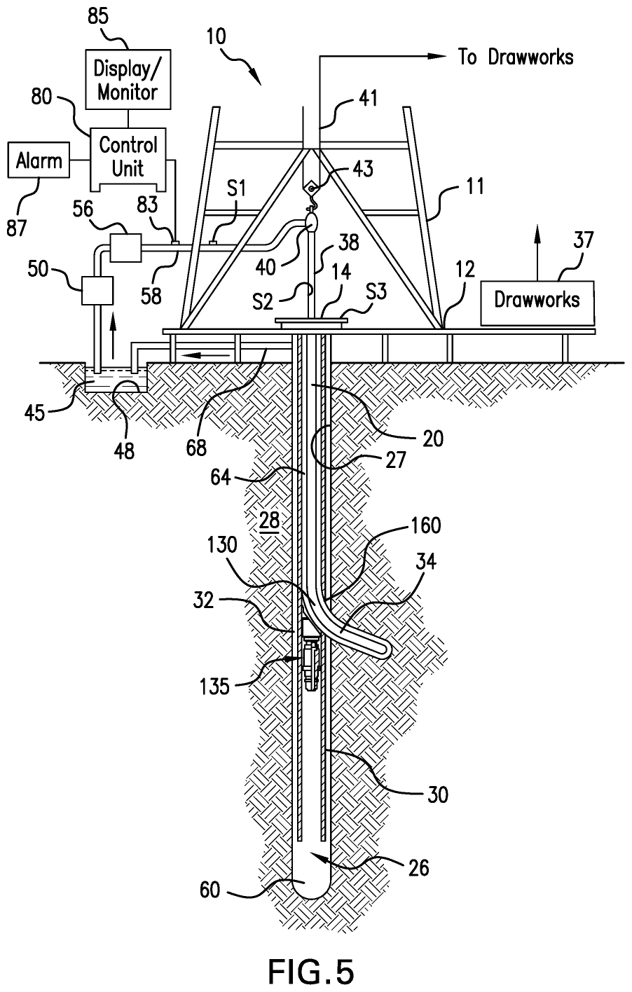

The ultrasonic wave may penetrate casing tubular 30, cement liner 32 and into geological formation 28. Receivers 156 are arranged circumferentially about tubular 140 and are operable to receive a reflection of the ultrasonic wave. In addition to being operable to detect parameters of casing tubular 30, cement liner 32 and geological formation 28, as discussed herein, surface control unit 80 may evaluate the reflected ultrasonic wave as casing exit BHA passes through a just formed casing window 160 (FIG. 5) formed in casing tubular 30. In this manner, operators may determine a shape as well as other qualities of casing window 160 formed by casing exit BHA 130. By evaluating the shape and other qualities of casing window 160 a determination may be made whether there is a need for additional polishing/shaping operations.

The reflected ultrasonic wave may be captured by receivers 156 and may be transferred to surface control unit 80 for evaluation. Operators at surface control system 80 may evaluate the reflected ultrasonic wave to identify whether a casing collar is present at the selected position. The reflected ultrasonic wave may also be evaluated to determine whether there is cement radially outwardly of the casing as well as the quality of the cement. Additionally, the reflected ultrasonic wave may be evaluated to determine casing integrity, e.g., to determine a thickness of casing tubular 30, a geometric shape of casing tubular 30, a thickness or quality of concrete liner 32 and/or properties of geological formation 28 at the selected position or positions. After evaluating casing collar location and cement quality, a determination may be made where to cut casing tubular 30. That is, casing tubular 30 is cut so as to avoid interfering with casing collars or other structure that might impede the cutting and/or pulling process as well as to avoid the negative impact on casing window milling performance due to lack of cement support behind the casing. Acquisition of casing integrity data also allows a user to determine reusability of casing interval between surface and casing exit kickoff point for the remaining of the production life of the well.

In an embodiment, cut and pull BHA 132 depicted in FIG. 4, includes a tubular 168 that may support a taper mill 170, a cutter 172 and a motor 174 that may drive cutter 172. Cut and pull BHA also includes an ultrasonic sensor system 180. In a manner similar to that discussed above, ultrasonic sensor system 180 includes a plurality of transceivers 1182 and a plurality of receivers 184. Transceivers 182 are arranged circumferentially about tubular 168 and are operable to emit an ultrasonic wave radially outwardly toward casing tubular 30. Receivers 184 are arranged circumferentially about tubular 168 and are operable to receive a reflection of the ultrasonic wave. The ultrasonic wave may penetrate casing tubular 30, cement liner 32 and into geological formation 28.

The reflected ultrasonic wave is captured by receivers 184 and may be transferred to surface control unit 80 for evaluation. Operators at surface control system 80 may evaluate the reflected ultrasonic wave to identify whether a casing collar is present at the selected position. The reflected ultrasonic wave may also be evaluated to determine casing integrity, e.g., to determine a thickness of casing tubular 30, a geometric shape of casing tubular 30, a thickness or quality of concrete liner 32 and/or properties of medium outside of casing including cement, mud settlement, oil/gas and geological formation 28 at the selected position or positions. With this information, a determination may be made where to cut casing tubular 30 to avoid interfering with casing collars or other structure that might impede the cutting and/or pulling process as well as to maximize the chance of successfully pulling the casing free.

Ultrasonic sensors can be incorporated in any of the above mentioned BHAs (casing exit, cut and pull, and wellbore cleanout) or any other drillpipe deployed operations.

Set forth below are some embodiments of the foregoing disclosure.

Embodiment 1. A method of forming a casing window in a casing tubular comprising: introducing a bottom hole assembly (BHA) into a casing tubular; running the bottom hole assembly to a selected position in the casing tubular; directing an ultrasonic wave from the BHA toward the casing tubular; receiving a reflection of the ultrasonic wave at the BHA; and evaluating the reflection of the ultrasonic wave to determine one or more parameters associated with the casing tubular and supporting structure.

Embodiment 2. The method according to any prior embodiment, wherein evaluating the reflection includes determining a location of a casing collar along the casing tubular.

Embodiment 3. The method according to any prior embodiment, wherein evaluating the reflection includes determining a thickness of the casing tubular.

Embodiment 4. The method according to any prior embodiment, wherein evaluating the reflection includes at least one of determining properties of medium outside of casing and determining a thickness of a cement layer extending between the casing tubular and a formation.

Embodiment 5. The method according to any prior embodiment, further comprising: positioning a whipstock in the casing tubular at the selected position.

Embodiment 6. The method according to any prior embodiment, further comprising: forming a casing window through the casing tubular at the selected position.

Embodiment 7. The method according to any prior embodiment, further comprising: directing another ultrasonic wave from the BHA toward the casing window; and receiving a reflection of the ultrasonic wave at the BHA.

Embodiment 8. The method according to any prior embodiment, further comprising: determining a shape of the casing window from the reflection of the ultrasonic wave.

Embodiment 9. The method according to any prior embodiment, further comprising: transmitting data associated with the reflection of the ultrasonic wave to data acquisition system arranged at a surface system.

Embodiment 10. The method according to any prior embodiment, wherein transmitting data includes communicating with the data acquisition system through a wired connection.

Embodiment 11. The method according to any prior embodiment, wherein transmitting data includes communicating with the data acquisition system through a wireless connection.

Embodiment 12. The method according to any prior embodiment, wherein the wireless connection includes delivering one or more mud pulses, electromagnetic signals, or acoustic signals to the data acquisition system.

Embodiment 13. A bottom hole assembly (BHA) comprising: a tubular member; at least one tool supported by the tubular member; and an ultrasonic sensor system mounted to the tubular member, the ultrasonic sensor system including at least one transceiver and at least one receiver, the at least one transceiver being mounted to project a ultrasonic wave radially outwardly of the tubular member.

Embodiment 14. The BHA according to any prior embodiment, wherein the at least one transceiver includes a plurality of transceivers arranged circumferentially about the tubular member and the at least one receiver includes a plurality of receivers arranged circumferentially about the tubular member.

Embodiment 15. The BHA according to any prior embodiment, wherein the BHA comprises at least one of a cleanout BHA, a casing exit BHA, and a cut and pull BHA.

Embodiment 16. The BHA according to any prior embodiment, further comprising: a communication system operable to deliver data from the ultrasonic sensor system to a surface system.

Embodiment 17. A resource exploration and recovery system comprising: a surface system; a subsurface system including a tubular string supporting a bottom hole assembly (BHA) including: a tubular member; at least one tool supported by the tubular member; and an ultrasonic sensor system mounted to the tubular member, the ultrasonic sensor system including at least one transceiver and at least one receiver, the at least one transceiver being mounted to project a ultrasonic wave radially outwardly of the tubular member.

Embodiment 18. The resource exploration and recovery system according to any prior embodiment, wherein the at least one transceiver includes a plurality of transceivers arranged circumferentially about the tubular member and the at least one receiver includes a plurality of receivers arranged circumferentially about the tubular member.

Embodiment 19. The resource exploration and recovery system according to any prior embodiment, wherein the BHA comprises at least one of a cleanout BHA, a casing exit BHA, and a cut and pull BHA.

Embodiment 20. The resource exploration and recovery system according to any prior embodiment, further comprising: a communication system operable to deliver data from the ultrasonic sensor system to a surface system.

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about” and “substantially” are intended to include the degree of error associated with measurement of the particular quantity based upon the equipment available at the time of filing the application. For example, “about” and/or “substantially” can include a range of 8% or 5%, or 2% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method of forming a casing window in a casing tubular comprising:
introducing a bottom hole assembly (BHA) into a casing tubular;
running the bottom hole assembly to a selected position in the casing tubular;
directing an ultrasonic wave from the BHA toward the casing tubular;
receiving a reflection of the ultrasonic wave at the BHA; and
evaluating the reflection of the ultrasonic wave to determine one or more parameters associated with the casing tubular and supporting structure.

2. The method of claim 1, wherein evaluating the reflection includes determining a location of a casing collar along the casing tubular.

3. The method of claim 1, wherein evaluating the reflection includes determining a thickness of the casing tubular.

4. The method of claim 1, wherein evaluating the reflection includes at least one of determining properties of medium outside of casing and determining a thickness of a cement layer extending between the casing tubular and a formation.

5. The method of claim 1, further comprising: positioning a whipstock in the casing tubular at the selected position.

6. The method of claim 5, further comprising: forming a casing window through the casing tubular at the selected position.

7. The method of claim 6, further comprising:
directing another ultrasonic wave from the BHA toward the casing window; and
receiving a reflection of the ultrasonic wave at the BHA.

8. The method of claim 7, further comprising: determining a shape of the casing window from the reflection of the ultrasonic wave.

9. The method of claim 1, further comprising: transmitting data associated with the reflection of the ultrasonic wave to data acquisition system arranged at a surface system.

10. The method of claim 9, wherein transmitting data includes communicating with the data acquisition system through a wired connection.

11. The method of claim 9, wherein transmitting data includes communicating with the data acquisition system through a wireless connection.

12. The method of claim 11, wherein the wireless connection includes delivering one or more mud pulses, electromagnetic signals, or acoustic signals to the data acquisition system.

13. A bottom hole assembly (BHA) comprising:
a tubular member,
at least one tool supported by the tubular member; and
an ultrasonic sensor system mounted to the tubular member, the ultrasonic sensor system including at least one transceiver and at least one receiver, the at least one transceiver being mounted to project a ultrasonic wave radially outwardly of the tubular member.

14. The BHA according to claim 13, wherein the at least one transceiver includes a plurality of transceivers arranged circumferentially about the tubular member and the at least one receiver includes a plurality of receivers arranged circumferentially about the tubular member.

15. The BHA according to claim 13, wherein the BHA comprises at least one of a cleanout BHA, a casing exit BHA, and a cut and pull BHA.

16. The BHA according to claim 13, further comprising: a communication system operable to deliver data from the ultrasonic sensor system to a surface system.

17. A resource exploration and recovery system comprising:
a surface system;
a subsurface system including a tubular string supporting a bottom hole assembly (BHA) including:
a tubular member,
at least one tool supported by the tubular member; and
an ultrasonic sensor system mounted to the tubular member, the ultrasonic sensor system including at least one transceiver and at least one receiver, the at least one transceiver being mounted to project a ultrasonic wave radially outwardly of the tubular member.

18. The resource exploration and recovery system according to claim 17, wherein the at least one transceiver includes a plurality of transceivers arranged circumferentially about the tubular member and the at least one receiver includes a plurality of receivers arranged circumferentially about the tubular member.

19. The resource exploration and recovery system according to claim 17, wherein the BHA comprises at least one of a cleanout BHA, a casing exit BHA, and a cut and pull BHA.

20. The resource exploration and recovery system according to claim 17, further comprising: a communication system operable to deliver data from the ultrasonic sensor system to a surface system.
